(19) United States
(12) Patent Application Publication
(10) Pub. No.: US 2024/0291698 A1
(43) Pub. Date: Aug. 29, 2024

(54) TRANSMIT SPECTRUM MASK IMPROVEMENT FOR EXTENDED-RANGE PACKET

(71) Applicant: NXP USA, Inc., Austin, TX (US)

(72) Inventors: Priyanka Bansal, Lakheri (IN); Hari Ram Balakrishnan, Chennai (IN); Sudhir Srinivasa, Los Gatos, CA (US); Rui Cao, Sunnyvale, CA (US)

(73) Assignee: NXP USA, Inc., Austin, TX (US)

(21) Appl. No.: 18/589,362

(22) Filed: Feb. 27, 2024

(30) Foreign Application Priority Data
Feb. 28, 2023 (IN) 202341013503

(51) Int. Cl. H04L 25/03; H04L 27/26

(52) U.S. Cl. CPC H04L 25/03866; H04L 27/2602

(57) ABSTRACT

A wireless communication system, apparatus, and methodology are described for enabling wireless communication devices to generate extended range Physical Layer Protocol Data Units (PPDUs) for wireless transmission to a destination communication devices by generating, at a first wireless communication device, a data sequence in which a plurality of repeated data symbols are encoded for wireless transmission to the second communication device, and then applying a scrambling sequence that is known to the first and second communication devices to the data sequence to generate an output data sequence wherein the plurality of repeated data symbols are pseudo-randomized prior to performing an inverse Fourier transform on the output data sequence.

### CROSS-REFERENCE TO RELATED APPLICATION AND PRIORITY CLAIM

This application claims the benefit of India Provisional Patent Application Ser. No. 202341013503, entitled “Transmit Spectrum Mask Improvement For Extended-Range Packet” filed on Feb. 28, 2023, which is incorporated by reference in its entirety as if fully set forth herein.

### BACKGROUND

### Field

The present disclosure is directed in general to wireless communication networks, systems, devices, and methods of operation. In one aspect, the present disclosure relates generally to transmit spectrum mask improvement for extended-range packet systems, devices, and methods of operation.

### Description of the Related Art

One of the requirements being looked at in the next-gen WLAN standard is range extension. Range extension schemes in general use repetition of symbols to gain the range in a power-limited scenario. However, repeated data symbols result in spreading of the spectrum which results in a poorer transmit spectral mask margin, i.e., the transmit power needs to be operated in a more linear region.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 illustrates a block diagram of a general scrambler which may be used to implement selected embodiments of the present disclosure;

FIG. 2 illustrates a block diagram of an 11-bit scrambler which may be used to implement selected embodiments of the present disclosure; and

FIG. 3 illustrates a 7-bit scrambler which may be used to implement selected embodiments of the present disclosure.

### DETAILED DESCRIPTION

The detailed description of the appended drawings is intended as a description of the embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

The present disclosure discloses a method to introduce randomness to repeated data symbols using a pseudo-random number (PN) sequence or a scrambler to improve the transmit spectral mask margin.

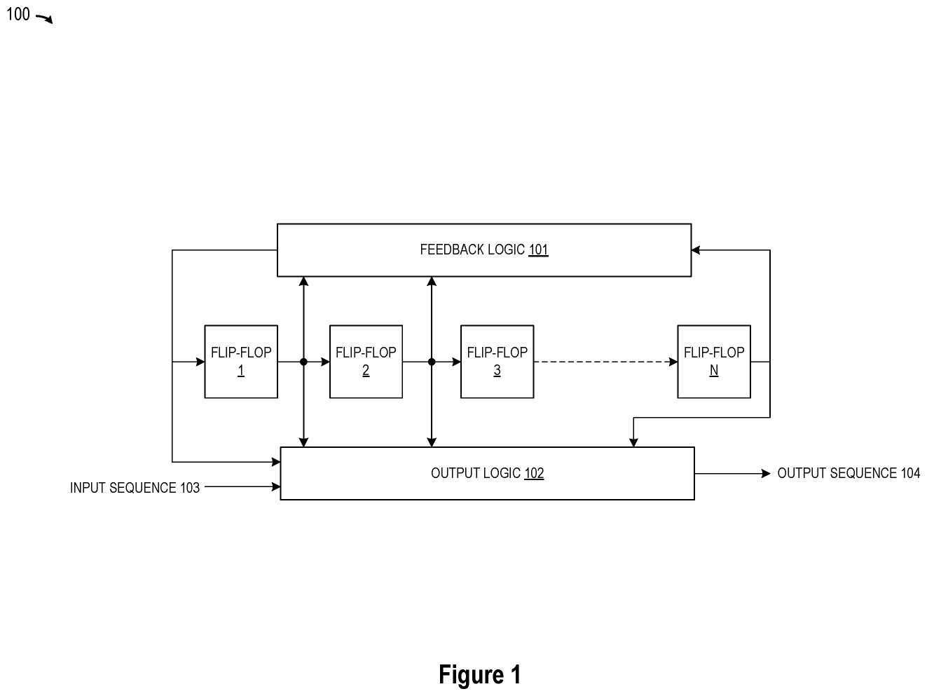

FIG. 1 illustrates a block diagram of a general scrambler 100 in accordance with an embodiment of the present disclosure. As illustrated, the scrambler 100 includes a plurality of flip-flops 1-N connected in series and with feedback logic 101 and output logic 102 to receive an input sequence 103 and to generate an output sequence 104, where each flip-flop (e.g., flip-flop 1) may be connected to an output flip-flop (e.g., flip-flop 2), the feedback logic 101, and/or the output logic 102. A PN sequence may be used alternatively to the general scrambler 100. The general scrambler 100 or PN sequence may be used at a modulated symbol level. The general scrambler 100 may be utilized in a wireless local area network (WLAN) standard to avoid the continuous repetition of ‘0’ or ‘1’ or a periodic pattern generated in the extended range physical layer protocol data unit (ER-PPDU) format. The general scrambler 100 or/and PN sequence may be used for repeated data symbols to improve spectral mask margin.

The general scrambler or PN sequence may be utilized for the ER PPDU with repeated ER data symbols and for a non-HT PPDU packet format. The general scrambler 100 or PN sequence of the present disclosure is used for data tones before IFFT for repeated data symbols.

The scrambler 100 may be utilized to enable improvement in the transmit spectrum. The general scrambler 100 or PN sequence may require an initial seed to generate the PN sequence. In general, the seed may be fixed in a plurality of ways including a function of Basic Service Set (BSS) color and various other parameters that are available at an access point (AP) and a station (STA). The AP may fix the seed respective to itself based on the ID of the AP. The seed may be assigned as a function of the station ID to which the packet is addressed.

The transmit spectrum may be further improved based on applying a polarity sequence to a subset of subcarriers. For example, a polarity sequence per 10 MHz is given as {a, b, c, d . . . } for a 20 MHz signal. For Nsd/2 tones, polarity {a} may be applied, and for the subsequent Nsd/2 tones polarity {b} may be applied, and for the subsequent data symbol's first half of the polarity {c} may be applied and polarity {d} may be applied to the latter half and so on. Here, Nsd may be considered as a number of data subcarriers. The subcarriers within a subset may be placed adjacent to each other or the subcarrier indices may be distributed across the signal bandwidth (BW).

Polarity may be alternatively introduced by grouping data differently for each of the repeated symbols. Further, a tone index may be utilized to identify the polarity of the tone. For example, for the 20 MHz signal, a polarity for the 10 MHz segment may be required. The polarity may be defined for each tone index as (−1)\hat{ }{k−i*N}, where k is the tone index, i is the repetition index, and N is offset. For a first data symbol, polarity may be applied for the data tones in the latter half, i.e., k={Nsd/2, Nsd}. Here, the offset may be considered as Nsd/2, and repetition may be 1. For a second data symbol, the polarity may be applied for data tones with k ={Nsd/4, 3Nsd/4}, the offset may be Nsd/4, and repetition may be 2. Similarly, the grouping may be executed for further repeated data symbols. Further, the Dual Carrier Modulation (DCM) pattern may be changed to introduce randomness in the data field. Dual carrier modulation is a well-known transmission scheme for achieving frequency diversity in wireless communications by modulating the same information on a pair of subcarriers which are typically spaced far apart in frequency. With conventional DCM schemes, each repeating data symbol has a DCM encoded frequency domain signal [x xDCM]. However, with the present disclosure, if DCM encoded frequency domain signal is [x xDCM], the subsequent data symbol may be interpreted as [xDCM X].

The present disclosure provides a method for solving the spectrum issue in the range extension packet. However, the present disclosure may also be applied to all the packet formats and obtain the spectrum improvement for low MCS (non-linear operating) regions. For example, the packet may be in DCM or duplicate (DUP) mode, and the present disclosure may be applied post to the application of polarity defined for DCM and DUP mode. Further, the present invention may also be applied before the definition of the polarity for DCM and DUP mode. In such a case, the polarity definition for DCM and DUP mode may be optional.

For the implementation of binary phase-shift keying (BPSK) or quadrature binary phase-shift keying (QPSK), the real and imaginary parts of the data sequence may be mapped to a sequence of 0's and 1's and may be fed to the general scrambler 100, separately. Both the output sequences (i.e., real and imaginary sequences) may be merged and remapped to the symbols. Further, the repetitions may be generated before applying the general scrambler 100 (or PN sequence). The equivalent operation may also be performed before constellation mapping by addressing the repetition nature. An arbitrary series, known at both transmitter and receiver, of 0's and 1's with a length proportional to the data sequence can be used as the input sequence for generating the PN sequence. Output PN sequence may then be multiplied by a modulated data sequence.

In QPSK, the multiplying factor may be generated for the PN sequence. Multiplication may be element-wise independent multiplication in the real and imaginary parts of the modulated data sequence. The multiplication may be ±1 per constellation point or maybe ((±1 ±li)/√2) per constellation point. In a generalized form, the PN sequence (‘0’ and ‘1’) may be grouped into bits and may be mapped to a phase-shift keying (PSK) constellation (e^{jθ}) form. The generated PSK constellation may multiply the constellation points which are required to be communicated. Modulation schemes containing higher order may be generated and multiplied with the data sequence similar to that of the QSPK.

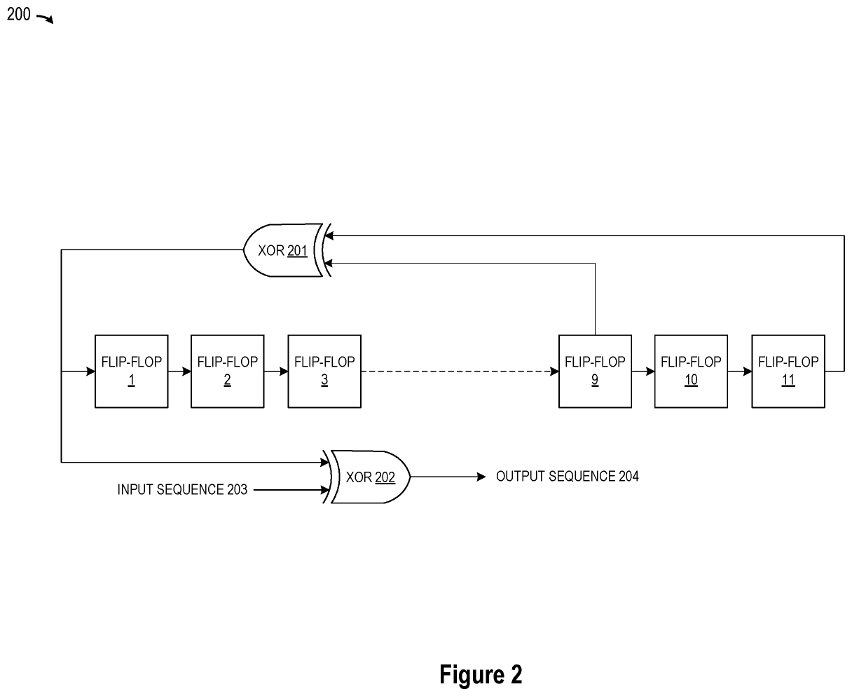

FIG. 2 illustrates a block diagram of an 11-bit scrambler 200 in accordance with an embodiment of the present disclosure. As illustrated, the scrambler 200 includes a plurality of flip-flops 1-11 connected in series and with an XOR gate 201 which provides feedback logic and XOR gate 202 which provides output logic to receive an input sequence 203 and to generate an output sequence 204, where cach flip-flop (e.g., flip-flop 1) may be connected to an output flip-flop (e.g., flip-flop 2), and with selected flip-flops (e.g., flip-flop 9 and flip-flop 10) being connected to the XOR gate/feedback logic 201. The general scrambler 100 that is defined in the 802.11 standards may be reused. The standard scrambler polynomial for the 11-bit scrambler may be given as G(z)=z⁻¹¹+z⁻⁹+1. The working of the 11-bit scrambler 200 may be the same as the general scrambler 100 described in FIG. 1.

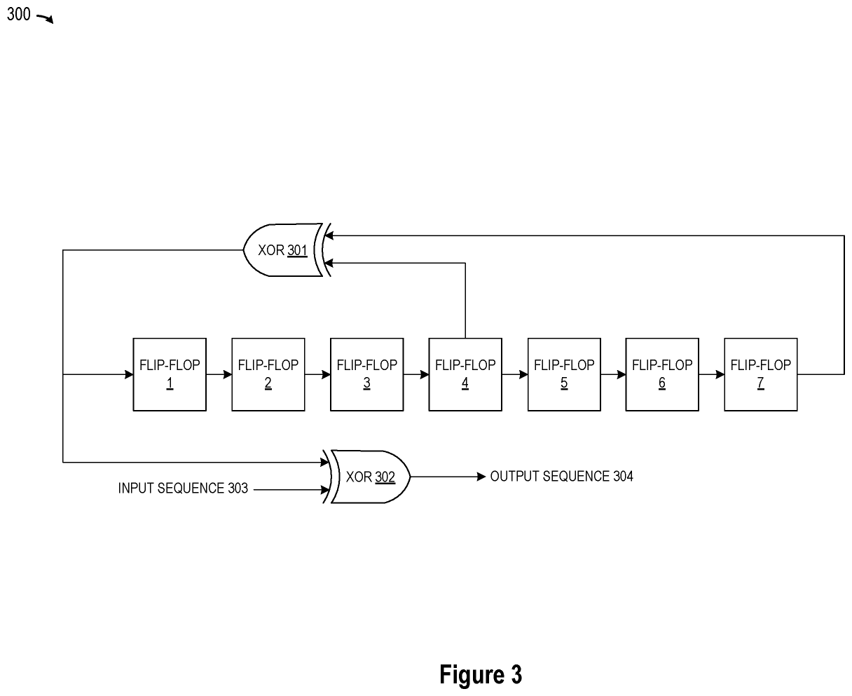

FIG. 3 illustrates a block diagram of a 7-bit scrambler 300 in accordance with an embodiment of the present disclosure. As illustrated, the scrambler 300 includes a plurality of flip-flops 1-7 connected in series and with an XOR gate 301 which provides feedback logic and XOR gate 302 which provides output logic to receive an input sequence 303 and to generate an output sequence 304, where each flip-flop (e.g., flip-flop 1) may be connected to an output flip-flop (e.g., flip-flop 2), and with selected flip-flops (e.g., flip-flop 9 and flip-flop 10) being connected to the XOR gate/feedback logic 201. The standard scrambler polynomial for the 7-bit scrambler 300 is given as G(z)=z⁻⁷+z⁻⁴+1. The working of the 7-bit scrambler 300 may be the same as the general scrambler 100 described in FIG. 1.

The present disclosure discloses using PN sequence on a per-tone basis for transmit spectrum improvement. The PN sequence is converted to an M-PSK signal and then multiplied with the data signal. B-PSK signal multiplication is used. Further, the 802.11-defined scrambler sequence is repurposed for this use case to remove the extra requirement on the new hardware. Different ways of forming the subset of subcarriers on which polarity sequence is applied. The present disclosure further discloses forming various subcarrier groups and applying the polarity generated for each subcarrier.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims. Further, unless stated otherwise, terms such as “first” and “second” are used to arbitrarily distinguish between the elements such terms describe. Thus, these terms are not necessarily intended to indicate temporal or other prioritization of such elements.

By now it should be appreciated that there has been provided a method, system, and apparatus for increasing transmit spectrum mask margin for extended range packets, such as a physical layer (PHY) protocol data unit (PPDU), which are generated at a first communication device for wireless transmission to a second communication device. In the disclosed methodology, the first communication device generates a data sequence in which a plurality of repeated data symbols are encoded for wireless transmission to the second communication device. In selected embodiments, the first communication device generates the data sequence by generating a plurality of modulated data symbols. In other selected embodiments, the first communication device generates the data sequence by generating a BPSK real data sequence, BPSK imaginary data sequence, a QPSK real data sequence, or a QPSK imaginary data sequence. In addition, the first communication device applies a scrambling sequence that is known to the first and second communication devices to the data sequence to generate an output data sequence wherein the plurality of repeated data symbols are pseudo-randomized prior to performing an inverse Fourier transform on the output data sequence. In selected embodiments, the first communication device applies the scrambling sequence by initializing a multi-bit scrambler with an initial seed value that is computed as a function of a Basic Service Set (BSS) color for the first and second communication devices, an access point (AP) identification (ID) for the first communication device, and/or station ID value of the second communication device; and then supplying the data sequence as an input sequence to the multi-bit scrambler to generate the output data sequence. In other selected embodiments, the first communication device applies the scrambling sequence by initializing a multi-bit scrambler with an initial seed value that is computed as a function of a Basic Service Set (BSS) color for the first and second communication devices, an access point (AP) identification (ID) for the first communication device, and/or station ID value of the second communication device; supplying a fixed input data sequence as an input sequence to the multi-bit scrambler to generate the scrambling sequence; mapping the scrambling sequence to a polarity sequence; and multiplying the data sequence by the polarity sequence to generate the output data sequence. In other selected embodiments, the first communication device applies the scrambling sequence by mapping the scrambling sequence to a pseudo-random polarity sequence; and applying the pseudo-random polarity sequence to subcarrier tones corresponding to the plurality of repeated data symbols in the data sequence by sequentially applying cach value of the pseudo-random polarity sequence to a corresponding subset of subcarrier tones, where each subset of subcarrier tones represents a different portion of a different data symbol. In selected embodiments, cach subset of subcarrier tones may be adjacent subcarrier tones, and in other selected embodiments, each subset of subcarrier tones may be subcarrier tones that are spaced apart from one another. In other selected embodiments, the first communication device applies the scrambling sequence by computing a plurality of polarity sequence values −1^{{k-i*N}}, where k is a subcarrier tone index value k, i is a data symbol repetition value, and N is an offset value. In such embodiments, the first communication device applies the plurality of polarity sequence values to a different subset of subcarrier tones for each data symbol from the plurality of repeated data symbols in the data sequence. In other selected embodiments, the first communication device applies the scrambling sequence by using alternating combinations of dual carrier modulation (DCM) patterns for repeated data symbols when generating the output data sequence. In other selected embodiments, the first communication device applies the scrambling sequence by initializing a multi-bit scrambler with an initial seed value, where the multi-bit scrambler comprises a plurality of flip-flops connected in series with feedback logic which is connected to generate a feedback signal for input to the plurality of flip-flops and to output logic which is also connected to receive the data sequence and to generate the output data sequence. In selected embodiments, the feedback logic may include a first XOR gate connected to receive outputs from at least two flip-flops from the plurality of flip-flops. In addition, the output logic may include a second XOR gate connected to receive an output from the first XOR gate and the data sequence.

In another form, there is provided a wireless communication device, system, and associated method of operation for generating a physical layer (PHY) protocol data unit (PPDU) for wireless transmission to a destination communication device in accordance with an Extremely High Throughput (EHT) communication protocol. As disclosed, the wireless communication device includes a processor that is configured to generate a data sequence in which a plurality of repeated data symbols are encoded for wireless transmission to the destination communication device. In addition, the processor is configured to apply a scrambling sequence to the data sequence to generate an output data sequence wherein the plurality of repeated data symbols are pseudo-randomized prior to performing an inverse Fourier transform on the output data sequence, and where the scrambling sequence is known to the wireless communication device and the destination communication device. In addition, the processor is configured to transmit the first PPDU in accordance with a transmit spectrum mask limit specified in accordance with an 802.11 wireless transmission protocol. In selected embodiments, the processor is configured to apply the scrambling sequence by mapping the scrambling sequence to a pseudo-random polarity sequence; and applying the pseudo-random polarity sequence to subcarrier tones corresponding to the plurality of repeated data symbols in the data sequence by sequentially applying each value of the pseudo-random polarity sequence to a corresponding subset of subcarrier tones, where each subset of subcarrier tones represents a different portion of a different data symbol. In other embodiments, the processor is configured to apply the scrambling sequence by initializing a multi-bit scrambler with an initial seed value that is computed as a function of a Basic Service Set (BSS) color for the first and second communication devices, an access point (AP) identification (ID) for the first communication device, and/or station ID value of the second communication device; and supplying the data sequence as an input sequence to the multi-bit scrambler to generate the output data sequence. In such embodiments, the multi-bit scrambler may include a plurality of flip-flops connected in series with feedback logic which is connected to generate a feedback signal for input to the plurality of flip-flops and to output logic which is also connected to receive the data sequence and to generate the output data sequence. In such embodiments, the feedback logic may include a first XOR gate connected to receive outputs from at least two flip-flops from the plurality of flip-flops. In addition, the output logic may include a second XOR gate connected to receive an output from the first XOR gate and the data sequence.

Although the described exemplary embodiments disclosed herein are directed to a wireless communication devices which use extended range physical layer (PHY) protocol data unit (PPDU) PPDUs in selected 802.11be-compliant wireless connectivity applications and methods for operating same, the present disclosure is not necessarily limited to the example embodiments which illustrate inventive aspects of the present disclosure that are applicable to a wide variety of circuit designs and operations. Thus, the particular embodiments disclosed above are illustrative only and should not be taken as limitations upon the present disclosure, as the disclosure may be modified and practiced in different but equivalent manners apparent to those skilled in the art having the benefit of the teachings herein. Accordingly, the identification of the design and configurations provided herein is merely by way of illustration and not limitation, and other arrangements or PPDU formats may be used. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various functions, blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for generating, at a first communication device, a first physical layer (PHY) protocol data unit (PPDU) for wireless transmission to a second communication device, comprising:
generating, by the first communication device, a data sequence in which a plurality of repeated data symbols are encoded for wireless transmission to the second communication device;
applying a scrambling sequence that is known to the first and second communication devices to the data sequence to generate an output data sequence wherein the plurality of repeated data symbols are pseudo-randomized prior to performing an inverse Fourier transform on the output data sequence.

2. The method of claim 1, wherein generating the data sequence comprises generating a plurality of modulated data symbols.

3. The method of claim 1, wherein generating the data sequence comprises generating a BPSK real data sequence, BPSK imaginary data sequence, a QPSK real data sequence, or a QPSK imaginary data sequence.

4. The method of claim 1, where applying the scrambling sequence comprises:
initializing a multi-bit scrambler with an initial seed value that is computed as a function of a Basic Service Set (BSS) color for the first and second communication devices, an access point (AP) identification (ID) for the first communication device, and/or station ID value of the second communication device; and
supplying the data sequence as an input sequence to the multi-bit scrambler to generate the output data sequence.

5. The method of claim 1, where applying the scrambling sequence comprises:
initializing a multi-bit scrambler with an initial seed value that is computed as a function of a Basic Service Set (BSS) color for the first and second communication devices, an access point (AP) identification (ID) for the first communication device, and/or station ID value of the second communication device;
supplying a fixed input data sequence as an input sequence to the multi-bit scrambler to generate the scrambling sequence;
mapping the scrambling sequence to a polarity sequence; and
multiplying the data sequence by the polarity sequence to generate the output data sequence.

6. The method of claim 1, wherein applying the scrambling sequence comprises:
mapping the scrambling sequence to a pseudo-random polarity sequence; and
applying the pseudo-random polarity sequence to subcarrier tones corresponding to the plurality of repeated data symbols in the data sequence by sequentially applying each value of the pseudo-random polarity sequence to a corresponding subset of subcarrier tones, where each subset of subcarrier tones represents a different portion of a different data symbol.

7. The method of claim 6, wherein each subset of subcarrier tones comprises adjacent subcarrier tones.

8. The method of claim 6, wherein each subset of subcarrier tones comprises subcarrier tones that are spaced apart from one another.

9. The method of claim 1, where applying the scrambling sequence comprises:
computing a plurality of polarity sequence values −1^{{k-i*N}}, where k is a subcarrier tone index value k, i is a data symbol repetition value, and N is an offset value.

10. The method of claim 9, further comprising applying the plurality of polarity sequence values to a different subset of subcarrier tones for each data symbol from the plurality of repeated data symbols in the data sequence.

11. The method of claim 1, where applying the scrambling sequence comprises using alternating combinations of dual carrier modulation (DCM) patterns for repeated data symbols when generating the output data sequence.

12. The method of claim 1, where applying the scrambling sequence comprises initializing a multi-bit scrambler with an initial seed value, where the multi-bit scrambler comprises a plurality of flip-flops connected in series with feedback logic which is connected to generate a feedback signal for input to the plurality of flip-flops and to output logic which is also connected to receive the data sequence and to generate the output data sequence.

13. The method of claim 12, where the feedback logic comprises a first XOR gate connected to receive outputs from at least two flip-flops from the plurality of flip-flops.

14. The method of claim 13, where the output logic comprises a second XOR gate connected to receive an output from the first XOR gate and the data sequence.

15. A wireless communication device, comprising:
a processor configured to generate a first physical layer (PHY) protocol data unit (PPDU) for wireless transmission to a destination communication device by:
generating a data sequence in which a plurality of repeated data symbols are encoded for wireless transmission to the destination communication device;
apply a scrambling sequence to the data sequence to generate an output data sequence wherein the plurality of repeated data symbols are pseudo-randomized prior to performing an inverse Fourier transform on the output data sequence, and where the scrambling sequence is known to the wireless communication device and the destination communication device; and
transmit the first PPDU in accordance with a transmit spectrum mask limit specified in accordance with an 802.11 wireless transmission protocol.

16. The wireless communication device of claim 15, where the processor is configured to apply the scrambling sequence by:
mapping the scrambling sequence to a pseudo-random polarity sequence; and
applying the pseudo-random polarity sequence to subcarrier tones corresponding to the plurality of repeated data symbols in the data sequence by sequentially applying each value of the pseudo-random polarity sequence to a corresponding subset of subcarrier tones, where each subset of subcarrier tones represents a different portion of a different data symbol.

17. The wireless communication device of claim 15, where the processor is configured to apply the scrambling sequence by:
initializing a multi-bit scrambler with an initial seed value that is computed as a function of a Basic Service Set (BSS) color for the first and second communication devices, an access point (AP) identification (ID) for the first communication device, and/or station ID value of the second communication device; and
supplying the data sequence as an input sequence to the multi-bit scrambler to generate the output data sequence.

18. The wireless communication device of claim 17, where the multi-bit scrambler comprises a plurality of flip-flops connected in series with feedback logic which is connected to generate a feedback signal for input to the plurality of flip-flops and to output logic which is also connected to receive the data sequence and to generate the output data sequence.

19. The wireless communication device of claim 18, where the feedback logic comprises a first XOR gate connected to receive outputs from at least two flip-flops from the plurality of flip-flops. 20 The wireless communication device of claim 19, where the output logic comprises a second XOR gate connected to receive an output from the first XOR gate and the data sequence.
